(19) United States
(12) Patent Application Publication
(10) Pub. No.: US 2024/0002649 A1
(43) Pub. Date: Jan. 4, 2024

(54) Thermoplastic Resin Composition and Molded Article Using Same

(71) Applicant: LOTTE CHEMICAL CORPORATION, Seoul (KR)

(72) Inventors: Sanghyun HONG, Uiwang-si (KR); Hanna KIM, Uiwang-si (KR); Kyunha BAN, Uiwang-si (KR); Bongjun SONG, Uiwang-si (KR)

(21) Appl. No.: 18/039,057

(22) PCT Filed: Nov. 24, 2021
(86) PCT No.: PCT/KR2021/017408

§ 371 Date: May 26, 2023

(30) Foreign Application Priority Data
Nov. 30, 2020 (KR) 10-2020-0165200

(51) Int. Cl. C08L 25/12

(52) U.S. Cl. CPC C08L 25/12; C08L 2205/025; C08L 2205/035; C08L 2207/53

(57) ABSTRACT

The present invention relates to a thermoplastic resin composition and a molded article produced therefrom, the thermoplastic resin composition comprising: a base resin containing (A1) 20-40 wt % of a butadiene-based rubber-modified aromatic vinyl-vinyl cyanide graft copolymer, (A2) 30-75 wt % of an aromatic vinyl-vinyl cyanide copolymer, and (B) 5-40 wt % of polyamide resin; (C) a polyether-ester-amide block copolymer having a crystallization temperature (Tc) of 145° C. or less in an amount of 1-15 parts by weight per 100 parts by weight of the base resin; and (D) maleic anhydride-aromatic vinyl-vinyl cyanide copolymer in an amount of 0.5 to 10 parts by weight per 100 parts by weight of the base resin.

### TECHNICAL FIELD

The present invention relates to a thermoplastic resin composition and a molded article using the same.

### BACKGROUND ART

Styrene-based resins represented by acrylonitrile-butadiene-styrene copolymer (ABS) resins are widely used in various applications due to their excellent formability, mechanical properties, appearance, secondary processability, and the like.

Molded articles produced using styrene-based resins can be applied to various products that do or do not require painting, for example, various interior/exterior materials for automobiles and/or electronic devices.

In some cases, painting is performed on a molded article produced from a styrene-based resin in order to impart aesthetic effects to various interior/exterior materials. In general, painting may be performed by electrostatic painting widely used in the art, but is not limited thereto. Electrostatic painting is a process of performing painting after imparting electrical conductivity to the surface of a molded article and, in order to apply electrostatic coating to a plastic molded article having high surface resistance, it is necessary to perform pretreatment, such as application of a conductive primer and the like, to the surface of the molded article.

Since application of the conductive primer increases the number of processes and a process time, it has been proposed in recent years to further add various conductive materials (for example, carbon nanotubes) and/or additives for expression of conductivity into a styrene-based resin such that a molded article can have a certain level of electrical conductivity.

However, the addition of the conductive material and/or additives for expression of conductivity to the styrene-based resin can cause unexpected degradation in various properties due to damage to property balance of the styrene-based resin.

Therefore, there is a need for development of a thermoplastic resin composition that can maintain good electrical conductivity and property balance.

### DISCLOSURE

### Technical Problem

The present invention is aimed at providing a thermoplastic resin composition that has good properties in terms of both electrical conductivity and impact resistance, and a molded article produced therefrom.

### Technical Solution

In accordance with one aspect of the present invention, a thermoplastic resin composition comprises: 100 parts by weight of a base resin comprising 20 to 40 wt % of (A1) a butadiene-based rubber-modified aromatic vinyl-vinyl cyanide graft copolymer, 30 to 75 wt % of (A2) an aromatic vinyl-vinyl cyanide copolymer, and 5 to 40 wt % of (B) a polyamide resin; 1 to 15 parts by weight of (C) a polyether-ester-amide block copolymer having a crystallization temperature (Tc) of 145° C. or less; and 0.5 to 10 parts by weight of (D) a maleic anhydride-aromatic vinyl-vinyl cyanide copolymer.

The (A1) butadiene-based rubber-modified aromatic vinyl-vinyl cyanide graft copolymer may have a core-shell structure in which the core is composed of a butadiene-based rubber polymer and the shell is formed by graft polymerization of an aromatic vinyl compound and a vinyl cyanide compound to the core.

The butadiene-based rubber polymer may have an average particle diameter of 0.2 to 1.0 μm.

The (A1) butadiene-based rubber-modified aromatic vinyl-vinyl cyanide graft copolymer may be an acrylonitrile-butadiene-styrene graft copolymer.

The (A2) an aromatic vinyl-vinyl cyanide copolymer may comprise 55 to 80 wt % of an aromatic vinyl compound-derived component and 20 to 45 wt % of a vinyl cyanide compound-derived component based on 100 wt %.

The (A2) an aromatic vinyl-vinyl cyanide copolymer may have a weight average molecular weight of 80,000 to 300,000 g/mol.

The (A2) an aromatic vinyl-vinyl cyanide copolymer may be a styrene-acrylonitrile copolymer.

The (B) polyamide resin may comprise polyamide 6, polyamide 66, polyamide 46, polyamide 11, polyamide 12, polyamide 610, polyamide 612, polyamide 6I, polyamide 6T, polyamide 4T, polyamide 410, polyamide 510, polyamide 1010, polyamide 1012, polyamide 10T, polyamide 1212, polyamide 12T, polyamide MXD6, or a combination thereof.

The (C) polyether-ester-amide block copolymer may be a reaction mixture of: an aminocarboxylic acid, lactam, or diamine-dicarboxylic acid salt having 6 or more carbon atoms; a polyalkylene glycol; and a dicarboxylic acid having 4 to 20 carbon atoms.

The (D) maleic anhydride-aromatic vinyl-vinyl cyanide copolymer may be a maleic anhydride-styrene-acrylonitrile copolymer.

The thermoplastic resin composition may further comprise at least one additive selected from nucleating agents, coupling agents, fillers, plasticizers, lubricants, release agents, antibacterial agents, heat stabilizers, antioxidants, UV stabilizers, flame retardants, colorants, and impact modifiers.

In accordance with another aspect of the invention, a molded article produced from the thermoplastic resin composition as set forth above is provided.

The molded article may have a notched Izod impact strength of 15 kgf·cm/cm or more, as measured on a ¼″ thick specimen in accordance with ASTM D256.

The molded article may have a surface resistance of about 1×10^{11.0} Ω/sq or less, as measured on a specimen (100 mm×100 mm×2 mm) using a surface resistance meter (Manufacturer: SIMCO-ION, Model: Worksurface Tester ST-4).

The molded article may have a painting thickness of 50 μm or more.

### Advantageous Effects

The present invention provides a thermoplastic resin composition exhibiting good properties in terms of both electrical conductivity and impact resistance and a molded article using the same.

In addition, the thermoplastic resin composition and the molded article produced therefrom exhibit good electrical conductivity and property balance to be widely applied to various products used with painting or without painting, particularly to a molded article requiring electrostatic painting.

### BEST MODE

Hereinafter, exemplary embodiments of the present invention will be described in detail. However, it should be understood that the following embodiments are provided by way of example and the present invention is not limited thereto and is defined only by the appended claims.

Unless otherwise specified, “average particle diameter” is a volume average diameter and means a Z-average particle diameter measured using a dynamic light scattering analyzer.

According to one embodiment of the present invention, a thermoplastic resin composition comprises: 100 parts by weight of a base resin comprising 20 to 40 wt % of (A1) a butadiene-based rubber-modified aromatic vinyl-vinyl cyanide graft copolymer, 30 to 75 wt % of (A2) an aromatic vinyl-vinyl cyanide copolymer, and 5 to 40 wt % of (B) a polyamide resin; 1 to 15 parts by weight of (C) a polyether-ester-amide block copolymer having a crystallization temperature (Tc) of 145° C. or less; and (D) 0.5 to 10 parts by weight of a maleic anhydride-aromatic vinyl-vinyl cyanide copolymer.

Hereinafter, each of the components of the thermoplastic resin composition will be described in detail.

(A1) Butadiene-Based Rubber-Modified Aromatic Vinyl-Vinyl Cyanide Graft Copolymer

In one embodiment, the butadiene-based rubber-modified aromatic vinyl-vinyl cyanide graft copolymer imparts good impact resistance to the thermoplastic resin composition. In one embodiment, the butadiene-based rubber-modified aromatic vinyl-vinyl cyanide graft copolymer may have a core-shell structure in which the core is composed of a butadiene-based rubber polymer and the shell is formed by graft polymerization of an aromatic vinyl compound and a vinyl cyanide compound to the core.

The butadiene-based rubber-modified aromatic vinyl-vinyl cyanide graft copolymer according to one embodiment may be prepared through graft polymerization of a monomer mixture comprising an aromatic vinyl compound and a vinyl cyanide compound to the butadiene-based rubber polymer by a typical polymerization method, such as emulsion polymerization, bulk polymerization, and the like.

The butadiene-based rubber polymer may be selected from the group consisting of a butadiene rubber polymer, a butadiene-styrene rubber polymer, a butadiene-acrylonitrile rubber polymer, a butadiene-acrylate rubber polymer, and mixtures thereof.

The aromatic vinyl compound may be selected from the group consisting of styrene, α-methyl styrene, p-methyl styrene, p-t-butyl styrene, 2,4-dimethyl styrene, chlorostyrene, vinyl toluene, vinyl naphthalene, and mixtures thereof.

The vinyl cyanide compound may be selected from the group consisting of acrylonitrile, methacrylonitrile, fumaronitrile, and mixtures thereof.

The butadiene-based rubber polymer may have an average particle diameter of 0.2 to 1.0 μm. For example, the butadiene-based rubber polymer may have an average particle diameter of 0.2 μm or more, 0.3 μm or more, 0.4 μm or more, 0.5 μm or more, 0.6 μm or more, 0.7 μm or more, 0.8 μm or more, or 0.9 μm or more, and 1.0 μm or less, 0.9 μm or less, 0.8 μm or less, 0.7 μm or less, 0.6 μm or less, 0.5 μm or less, 0.4 μm or less, or 0.3 μm or less. Within this range of the average particle diameter of the butadiene-based rubber polymer, the thermoplastic resin composition according to one embodiment and a molded article produced therefrom have good impact resistance and appearance characteristics.

Based on 100 wt % of the butadiene-based rubber-modified aromatic vinyl-vinyl cyanide graft copolymer, the butadiene-based rubber polymer may be present in an amount of 40 to 70 wt %, for example, 40 to 65 wt %, 45 to 65 wt %, 45 to 60 wt %, 45 to 55 wt %, or 45 to 50 wt %. On the other hand, the aromatic vinyl compound and the vinyl cyanide compound grafted to the core composed of the butadiene-based rubber polymer may be present in a weight ratio of 1.5:1 to 4:1, for example, 2:1 to 3:1.

In one embodiment, the butadiene-based rubber-modified aromatic vinyl-vinyl cyanide graft copolymer may be an acrylonitrile-butadiene-styrene graft copolymer.

The butadiene-based rubber-modified aromatic vinyl-vinyl cyanide graft copolymer may be present in an amount of 20 wt % to 40 wt %, for example, 20 wt % or more, 25 wt % or more, 30 wt % or more, or 35 wt % or more, and 40 wt % or less, 35 wt % or less, 30 wt % or less, or 25 wt % or less, based on 100 wt % of the base resin. Within this range of the butadiene-based rubber-modified aromatic vinyl-vinyl cyanide graft copolymer, the thermoplastic resin composition and a molded article produced therefrom can exhibit good electrical conductivity and impact resistance.

(A2) Aromatic Vinyl-Vinyl Cyanide Copolymer

In one embodiment, the aromatic vinyl-vinyl cyanide copolymer serves to improve fluidity of the thermoplastic resin composition while securing a predetermined level of compatibility between the components thereof.

In one embodiment, the aromatic vinyl-vinyl cyanide copolymer may have a weight average molecular weight of 80,000 to 300,000 g/mol, for example, 80,000 to 200,000 g/mol, for example, 80,000 to 150,000 g/mol, for example, 80,000 g/mol or more, 85,000 g/mol or more, 90,000 g/mol or more, 100,000 g/mol or more, 120,000 g/mol or more, 150,000 g/mol or more, 200,000 g/mol or more, or 250,000 g/mol or more, and 300,000 g/mol or less, 250,000 g/mol or less, 200,000 g/mol or less, 150,000 g/mol or less, or 100,000 g/mol or less.

In one embodiment, the aromatic vinyl-vinyl cyanide copolymer may be prepared through polymerization of a monomer mixture comprising an aromatic vinyl compound and a vinyl cyanide compound by a typical polymerization method, such as emulsion polymerization, suspension polymerization, solution polymerization, bulk polymerization, and the like.

The aromatic vinyl compound may be selected from the group consisting of styrene, α-methyl styrene, p-methyl styrene, p-t-butyl styrene, 2,4-dimethyl styrene, chlorostyrene, vinyl toluene, vinyl naphthalene, and mixtures thereof.

The vinyl cyanide compound may be selected from the group consisting of acrylonitrile, methacrylonitrile, fumaronitrile, and mixtures thereof.

The aromatic vinyl-vinyl cyanide copolymer may comprise a component derived from the aromatic vinyl compound in an amount of 55 to 80 wt %, for example, 60 to 75 wt %, for example, 55 wt % or more, 60 wt % or more, 65 wt % or more, 70 wt % or more, or 75 wt % or more, and 80 wt % or less, 75 wt % or less, 70 wt % or less, 65 wt % or less, or 60 wt % or less, based on 100 wt %.

In one embodiment, the aromatic vinyl-vinyl cyanide copolymer may be a styrene-acrylonitrile (SAN) copolymer.

In one embodiment, the aromatic vinyl-vinyl cyanide copolymer may be present in an amount of 30 to 75 wt %, for example, 30 wt % or more, 35 wt % or more, 40 wt % or more, 45 wt % or more, 50 wt % or more, 55 wt % or more, 60 wt % or more, 65 wt % or more, or 70 wt % or more, and 75 wt % or less, 70 wt % or less, 65 wt % or less, 60 wt % or less, 55 wt % or less, 50 wt % or less, 45 wt % or less, 40 wt % or less, or 35 wt % or less, based on 100 wt % of the base resin. Within this range of the aromatic vinyl-vinyl cyanide copolymer, the thermoplastic resin composition and a molded article produced therefrom can exhibit good formability and mechanical properties.

(B) Polyamide Resin

In one embodiment, the polyamide resin allows the thermoplastic resin composition to realize good electrical conductivity.

In one embodiment, the polyamide resin may be selected from various polyamide resins known to those skilled in the art and may include, for example, an aromatic polyamide resin, an aliphatic polyamide resin, or a mixture thereof, without being limited thereto.

The aromatic polyamide resin is a polyamide having an aromatic group in a main chain and may be a wholly-aromatic polyamide, a semi-aromatic polyamide, or a mixture thereof.

The wholly-aromatic polyamide means a polymer of an aromatic diamine and an aromatic dicarboxylic acid, and the semi-aromatic polyamide means an aromatic polyamide containing at least one aromatic unit and at least one non-aromatic unit between amide bonds. For example, the semi-aromatic polyamide may be a polymer of an aromatic diamine and an aliphatic dicarboxylic acid or a polymer of an aliphatic diamine and an aromatic dicarboxylic acid.

The aliphatic polyamide means a polymer of an aliphatic diamine and an aliphatic dicarboxylic acid.

The aromatic diamine may include, for example, p-xylene diamine, m-xylene diamine, and the like, without being limited thereto. These may be used alone or as a mixture thereof.

The aromatic dicarboxylic acid may include, for example, phthalic acid, isophthalic acid, terephthalic acid, 2,6-naphthalenedicarboxylic acid, (1,3-phenylenedioxy)diacetic acid, and the like, without being limited thereto. These may be used alone or as a mixture thereof.

The aliphatic diamine may include, for example, ethylenediamine, trimethylenediamine, hexamethylenediamine, dodecamethylenediamine, piperazine, and the like, without being limited thereto. These may be used alone or as a mixture thereof.

The aliphatic dicarboxylic acid may include, for example, adipic acid, sebacic acid, succinic acid, glutaric acid, azelaic acid, dodecanedioic acid, dimeric acid, cyclohexanedicarboxylic acid, and the like, without being limited thereto. These may be used alone or as a mixture thereof.

In one embodiment, the polyamide resin may comprise polyamide 6, polyamide 66, polyamide 46, polyamide 11, polyamide 12, polyamide 610, polyamide 612, polyamide 6I, polyamide 6T, polyamide 4T, polyamide 410, polyamide 510, polyamide 1010, polyamide 1012, polyamide 10T, polyamide 1212, polyamide 12T, polyamide MXD6, or a combination thereof.

In one embodiment, the polyamide resin may comprise at least polyamide 6.

In one embodiment, the polyamide resin may be present in an amount of 5 to 40 wt %, for example, 5 to 35 wt %, for example, 5 to 30 wt %, for example, 5 to 25 wt %, for example, 5 to 20 wt %, based on 100 wt % of the base resin.

Within this range of the polyamide resin, the thermoplastic resin composition and a molded article produced therefrom can exhibit good mechanical properties and electrical conductivity.

(C) Polyether-Ester-Amide Block Copolymer

In one embodiment, the polyether-ester-amide block copolymer allows the thermoplastic resin composition and a molded article produced therefrom to exhibit a predetermined level of electrical conductivity.

In addition, the polyether-ester-amide block copolymer allows the thermoplastic resin composition and a molded article produced therefrom to exhibit such electrical conductivity while maintaining good property balance.

The polyether-ester-amide block copolymer may have a crystallization temperature Tc of 145° C. or less, as measured by differential scanning calorimetry (DSC). For example, the polyether-ester-amide block copolymer may have a crystallization temperature of 145° C. or less, 140° C. or less, 135° C. or less, 130° C. or less, or 125° C. or less. Within this range of the crystallization temperature, the thermoplastic resin composition and a molded article produced therefrom can exhibit good electrical conductivity.

In one embodiment, the polyether-ester-amide block copolymer may be, for example, a reaction mixture comprising an amino-carboxylic acid, lactam or diamine-dicarboxylic acid salt having 6 or more carbon atoms; a polyalkylene glycol; and a dicarboxylic acid having 4 to 20 carbon atoms.

In one embodiment, the aminocarboxylic acid, lactam, or diamine-dicarboxylic acid salt having 6 or more carbon atoms may include aminocarboxylic acids, such as ω-aminocaproic acid, ω-aminoenanthic acid, ω-aminocaprylic acid, ω-aminopelargonic acid, ω-aminocapric acid, 11-aminoundecanoic acid, 12-aminododecanoic acid, and the like; lactams, such as ε-caprolactam, enanthlactam, capryl lactam, laurolactam, and the like; and salts of diamines and dicarboxylic acids, such as salts of hexamethylenediamine-adipic acid, salts of hexamethylenediamine-isophthalic acid, and the like. For example, 12-aminododecanoic acid, ε-caprolactam, and salts of hexamethylenediamine-adipic acid, and the like may be used.

In one embodiment, the polyalkylene glycol may include polyethylene glycol, polytetramethylene glycol, polyhexamethylene glycol, a block or random copolymer of ethylene glycol and propylene glycol, a copolymer of ethylene glycol and tetrahydrofuran, and the like. For example, polyethylene glycol, a copolymer of ethylene glycol and propylene glycol, and the like may be used.

In one embodiment, the dicarboxylic acid having 4 to 20 carbon atoms may include terephthalic acid, 1,4-cyclohexanedicarboxylic acid, sebacic acid, adipic acid, dodecanedioic acid, and the like.

In one embodiment, a bond between the aminocarboxylic acid, lactam or diamine-dicarboxylic acid salt having 6 or more carbon atoms and the polyalkylene glycol may be an ester bond; a bond between the aminocarboxylic acid, lactam or diamine-dicarboxylic acid salt having 6 or more carbon atoms and the dicarboxylic acid having 4 to 20 carbon atoms may be an amide bond; and a bond between the polyalkylene glycol and the dicarboxylic acid having 4 to 20 carbon atoms may be an ester bond.

In one embodiment, the polyether-ester-amide block copolymer may be prepared by a method well-known in the art and may include, for example, by a method disclosed in JP Patent Publication No. S56-045419 or JP Unexamined Patent Publication No. S55-133424.

In one embodiment, the polyether-ester-amide block copolymer may comprise 10 to about 95 wt % of a polyether-ester block. Within this range, the thermoplastic resin composition and a molded article produced therefrom can exhibit good properties in terms of electrical conductivity, heat resistance, and the like.

In one embodiment, the polyether-ester-amide block copolymer may be present in an amount of 1 to 15 parts by weight, for example, 1 part by weight or more, 5 parts by weight or more, or 10 parts by weight or more, and 15 parts by weight or less, 10 parts by weight or less, or 5 parts by weight or less, relative to 100 parts by weight of the base resin. Within this range of the polyether-ester-amide block copolymer, the thermoplastic resin composition and a molded article produced therefrom can exhibit good electrical conductivity while maintaining good waterproof reliability.

(D) Maleic Anhydride-Aromatic Vinyl-Vinyl Cyanide Copolymer

In one embodiment, the maleic anhydride-aromatic vinyl-vinyl cyanide copolymer serves to maintain a suitable level of property balance of the thermoplastic resin composition and a molded article produced therefrom. Specifically, the maleic anhydride-aromatic vinyl-vinyl cyanide copolymer can maintain good properties (for example, impact resistance, heat resistance, and the like) of the thermoplastic resin composition, which can be deteriorated upon addition of the (C) polyether-ester-amide block copolymer.

In one embodiment, the maleic anhydride-aromatic vinyl-vinyl cyanide copolymer may be prepared through polymerization of a monomer mixture comprising maleic anhydride, an aromatic vinyl compound and a vinyl cyanide compound by a typical polymerization method, such as suspension polymerization, solution polymerization, bulk polymerization, and the like.

The aromatic vinyl compound may be selected from the group consisting of styrene, α-methyl styrene, p-methyl styrene, p-t-butyl styrene, 2,4-dimethyl styrene, chlorostyrene, vinyl toluene, vinyl naphthalene, and mixtures thereof.

The vinyl cyanide compound may be selected from the group consisting of acrylonitrile, methacrylonitrile, fumaronitrile, and mixtures thereof.

The maleic anhydride-aromatic vinyl-vinyl cyanide copolymer may be present in any copolymerization form and may have a structure in which a maleic anhydride-derived component, an aromatic vinyl compound-derived component and a vinyl cyanide compound-derived component constitute an alternating copolymer, a random copolymer, or a block copolymer, or a structure in which the maleic anhydride-derived component is grafted to a main chain to which the aromatic vinyl compound-derived component and the vinyl cyanide compound-derived component are copolymerized.

In one embodiment, the maleic anhydride-aromatic vinyl-vinyl cyanide copolymer may be a maleic anhydride-styrene-acrylonitrile copolymer.

The maleic anhydride-aromatic vinyl-vinyl cyanide copolymer may comprise 0.5 to 30 wt % of the maleic anhydride-derived component, 50 to 90 wt % of the aromatic vinyl compound-derived component, and 5 to 40 wt % of the vinyl cyanide compound-derived component, based on 100 wt %. Within this range of the maleic anhydride-aromatic vinyl-vinyl cyanide copolymer, the thermoplastic resin composition and a molded article produced therefrom can exhibit good impact resistance and/or heat resistance.

In one embodiment, the maleic anhydride-aromatic vinyl-vinyl cyanide copolymer may be present in an amount of 0.5 to 10 parts by weight, for example, 0.5 to 9 parts by weight, for example, 0.5 to 8 parts by weight, for example, 1 to 8 parts by weight, for example, 1 to 7 parts by weight, for example, 1 to 6 parts by weight, for example, 1 to 5 parts by weight, relative to 100 parts by weight of the base resin.

Within this content range of the maleic anhydride-aromatic vinyl-vinyl cyanide copolymer, the thermoplastic resin composition and a molded article produced therefrom can exhibit good electrical conductivity while maintaining good property balance.

(E) Additive

In addition to the components (A1) to (D), the thermoplastic resin composition according to one embodiment may further comprise at least one type of additive in order to secure balance between properties under conditions of maintaining good properties in terms of both electrical conductivity and property balance, or according to final purpose of the thermoplastic resin composition, as needed.

Specifically, the additives may include nucleating agents, coupling agents, fillers, plasticizers, lubricants, release agents, antibacterial agents, heat stabilizers, antioxidants, UV stabilizers, flame retardants, colorants, impact modifiers, and the like. These may be used alone or in combination thereof.

These additives may be present in a suitable amount within the range not causing deterioration in properties of the thermoplastic resin composition, specifically in an amount of 20 parts by weight or less relative to 100 parts by weight of the base resin, without being limited thereto.

The thermoplastic resin composition according to the present invention may be prepared by a typical method known to those skilled in the art.

For example, the thermoplastic resin composition according to the present invention may be prepared in pellet form by simultaneously mixing the aforementioned components of the present invention and other additives, followed by melt kneading in an extruder.

A molded article according to one embodiment may be produced from the thermoplastic resin composition set forth above.

In one embodiment, the molded article may have a notched Izod impact strength of 15 kgf·cm/cm or more, as measured on a ¼″ thick specimen in accordance with ASTM D256. For example, the molded article may have a notched Izod impact strength of 15 kgf·cm/cm or more, 16 kgf·cm/cm or more, 17 kgf·cm/cm or more, 18 kgf·cm/cm or more, 19 kgf·cm/cm or more, or 20 kgf·cm/cm or more.

In one embodiment, the molded article may have a surface resistance of 10¹¹ Ω/sq or less, for example, 10^{10.9} Ω/sq or less, for example, 10^{10.8} Ω/sq or less, for example, 10^{10.7} Ω/sq or less, as measured on a specimen (100 mm×100 mm×2 mm) using a surface resistance meter (Manufacturer: SIMCO-ION, Model: Worksurface Tester ST-4).

In one embodiment, the molded article may have a painting thickness of 50 μm or more. For example, the molded article may have a painting thickness of 50 μm or more, 51 μm or more, 52 μm or more, 53 μm or more, 54 μm or more, or 55 μm or more.

As such, the thermoplastic resin composition has good impact resistance and electrical conductivity and thus can be widely applied to various products used with painting or without painting, particularly to a molded article requiring electrostatic painting.

Next, the present invention will be described in more detail with reference to some examples. It should be understood that these examples are provided for illustration only and are not to be in any way construed as limiting the invention.

### Examples 1 and 2 and Comparative Examples 1 to 3

Thermoplastic resin compositions of Examples 1 and 2 and Comparative Examples 1 to 3 were prepared in composition ratios as listed in Table 1.

In Table 1, (A1), (A2) and (B) are included in a base resin and are represented in wt % based on the total weight of the base resin, and (C1) to (C4), and (D) included in a base resin and are represented in parts by weight relative to 100 parts by weight of the base resin.

The components listed in Table 1 were subjected to dry mixing and continuously supplied in quantitative amounts to a twin-screw extruder (L/D=44, f=45 mm), followed by melting/kneading. Then, specimens for evaluation of properties were prepared by drying the thermoplastic resin composition prepared in pellet form at 80° C. for about 4 hours, followed by injection molding using a 120 ton injection molding machine at a cylinder temperature of about 240° C. and a mold temperature of about 60° C.

TABLE 1

| | Example | | Comparative Example | | |
|---|---|---|---|---|---|
| | 1 | 2 | 1 | 2 | 3 |
| (A1) | 28 | 28 | 28 | 28 | 28 |
| (A2) | 57 | 57 | 57 | 57 | 57 |
| (B) | 15 | 15 | 15 | 15 | 15 |
| (C1) | 8 | — | — | — | 8 |
| (C2) | — | 8 | — | — | — |
| (C3) | — | — | 8 | — | — |
| (C4) | — | — | — | 8 | — |
| (D) | 4 | 4 | 4 | 4 | — |

Details of the components listed in Table 1 are as follows.

(A1) Butadiene-Based Rubber-Modified Aromatic Vinyl-Vinyl Cyanide Graft Copolymer

Acrylonitrile-butadiene-styrene graft copolymer (Lotte Chemical Corp.) comprising about 58 wt % of a core (average particle diameter: about 0.25 μm) composed of a butadiene rubber polymer and a shell formed by graft polymerization of acrylonitrile and styrene (acrylonitrile:styrene=about 2.5:7.5 (weight ratio))

(A2) Aromatic Vinyl-Vinyl Cyanide Copolymer

Styrene-acrylonitrile copolymer (Lotte Chemical Corp.) prepared through copolymerization of a monomer mixture comprising about 28 wt % of acrylonitrile and about 72 wt % of styrene and having a weight average molecular weight of about 110,000 g/mol

(B) Polyamide Resin

Polyamide 6 having a melting point (Tm) of about 223° C. and a relative viscosity of about 2.3 (EN-300, KP ChemTech Co., Ltd.)

(C) Polyether-Ester-Amide Block Copolymer

(C1) Polyamide 6-polyethylene oxide block copolymer having a melting point (Tm) of about 197° C. and a crystallization temperature (Tc) of about 126° C. (Sanyo Chemical Ind., Ltd.)

(C2) Polyamide 6-polyethylene oxide block copolymer having a melting point (Tm) of about 202° C. and a crystallization temperature (Tc) of about 138° C. (Sanyo Chemical Ind., Ltd.)

(C3) Polyamide 6-polyethylene oxide block copolymer having a melting point (Tm) of about 196° C. and a crystallization temperature (Tc) of about 150° C. (Sanyo Chemical Ind., Ltd.)

(C4) Polyamide 6-polyethylene oxide block copolymer having a melting point (Tm) of about 219° C. and a crystallization temperature (Tc) of about 184° C. (Sanyo Chemical Ind., Ltd.)

(D) Maleic Anhydride-Aromatic Vinyl-Vinyl Cyanide Copolymer

Maleic anhydride-styrene-acrylonitrile copolymer (SAM-010, Fine Blend Polymer Co., Ltd.)

### Experimental Example

Experimental results are shown in Table 2.

(1) Surface resistance (unit: Ω/sq): Surface resistance was measured on a specimen having a size of 100 mm×100 mm×2 mm using a surface resistance meter (Manufacturer: SIMCO-ION, Model: Work surface Tester ST-4).

(2) Impact strength (unit: kgf·cm/cm): Notched Izod impact strength was measured on a ¼″ thick specimen in accordance with ASTM D256.

(3) Painting thickness (unit: μm): Painting thickness was measured by thickness comparison between a painted portion and a non-painted portion using a micrometer after painting a specimen having a size of 100 mm×100 mm×2 mm with two-component type paints for electrostatic painting (KCC Corp.).

TABLE 2

| | Example | | Comparative Example | | |
|---|---|---|---|---|---|
| | 1 | 2 | 1 | 2 | 3 |
| Surface resistance | 10^{10.7} | 10^{10.4} | 10^{11.3} | 10^{12.0} | 10^{10.3} |
| Izod impact strength | 19 | 21 | 11 | 9 | 12 |
| Painting thickness | 52 | 56 | 43 | 35 | 55 |

From Tables 1 and 2, it can be seen that, when the thermoplastic resin composition is prepared using suitable amounts of the butadiene-based rubber-modified aromatic vinyl-vinyl cyanide graft copolymer, the aromatic vinyl-vinyl cyanide copolymer, the polyamide resin, polyether-ester-amide block copolymer, and the maleic anhydride-aromatic vinyl-vinyl cyanide copolymer as in Examples 1 and 2, the thermoplastic resin composition and a molded article produced therefrom have better electrical conductivity and impact resistance than the thermoplastic resin compositions of Comparative Examples, and secure good efficiency in electrostatic painting.

Although some exemplary embodiments have been described above, it should be understood that the present invention is not limited thereto and various modifications, changes, alterations, and equivalent embodiments can be made by those skilled in the art without departing from the spirit and scope of the invention.

1. A thermoplastic resin composition comprising:
100 parts by weight of a base resin comprising 20 to 40 wt % of (A1) a butadiene-based rubber-modified aromatic vinyl-vinyl cyanide graft copolymer, 30 to 75 wt % of (A2) an aromatic vinyl-vinyl cyanide copolymer, and 5 to 40 wt % of (B) a polyamide resin;
1 to 15 parts by weight of (C) a polyether-ester-amide block copolymer having a crystallization temperature (Tc) of 145° C. or less; and
0.5 to 10 parts by weight of (D) a maleic anhydride-aromatic vinyl-vinyl cyanide copolymer.

2. The thermoplastic resin composition according to claim 1, wherein the (A1) butadiene-based rubber-modified aromatic vinyl-vinyl cyanide graft copolymer has a core-shell structure in which the core is composed of a butadiene-based rubber polymer and the shell is formed by graft polymerization of an aromatic vinyl compound and a vinyl cyanide compound to the core.

3. The thermoplastic resin composition according to claim 2, wherein the butadiene-based rubber polymer has an average particle diameter of 0.2 to 1.0 μm.

4. The thermoplastic resin composition according to claim 1, wherein the (A1) butadiene-based rubber-modified aromatic vinyl-vinyl cyanide graft copolymer is an acrylonitrile-butadiene-styrene copolymer.

5. The thermoplastic resin composition according to claim 1, wherein the (A2) aromatic vinyl-vinyl cyanide copolymer comprises 55 to 80 wt % of an aromatic vinyl compound-derived component and 20 to 45 wt % of a vinyl cyanide compound-derived component based on 100 wt %.

6. The thermoplastic resin composition according to claim 1, wherein the (A2) aromatic vinyl-vinyl cyanide copolymer has a weight average molecular weight of 80,000 to 300,000 g/mol.

7. The thermoplastic resin composition according to claim 1, wherein the (A2) aromatic vinyl-vinyl cyanide copolymer is a styrene-acrylonitrile copolymer.

8. The thermoplastic resin composition according to claim 1, wherein the (B) polyamide resin comprises polyamide 6, polyamide 66, polyamide 46, polyamide 11, polyamide 12, polyamide 610, polyamide 612, polyamide 6I, polyamide 6T, polyamide 4T, polyamide 410, polyamide 510, polyamide 1010, polyamide 1012, polyamide 10T, polyamide 1212, polyamide 12T, polyamide MXD6, or a combination thereof.

9. The thermoplastic resin composition according to claim 1, wherein the (C) polyether-ester-amide block copolymer is a reaction mixture of: an aminocarboxylic acid, lactam, or diamine-dicarboxylic acid salt having 6 or more carbon atoms; a polyalkylene glycol; and a dicarboxylic acid having 4 to 20 carbon atoms.

10. The thermoplastic resin composition according to claim 1, wherein the (D) maleic anhydride-aromatic vinyl-vinyl cyanide copolymer is a maleic anhydride-styrene-acrylonitrile copolymer.

11. The thermoplastic resin composition according to claim 1, further comprising: at least one additive selected from nucleating agents, coupling agents, fillers, plasticizers, lubricants, release agents, antibacterial agents, heat stabilizers, antioxidants, UV stabilizers, flame retardants, colorants, and impact modifiers.

12. A molded article produced from the thermoplastic resin composition according to claim 1.

13. The molded article according to claim 12, wherein the molded article has a notched Izod impact strength of 15 kgf·cm/cm or more, as measured on a ¼″ thick specimen in accordance with ASTM D256.

14. The molded article according to claim 12, wherein the molded article has a surface resistance of about 1×10^{11.0} Ω/sq or less, as measured on a specimen (100 mm×100 mm×2 mm) using a surface resistance meter (Manufacturer: SIMCO-ION, Model: Worksurface Tester ST-4).

15. The molded article according to claim 12, wherein the molded article has a painting thickness of 50 μm or more.
